(19) United States
(12) Patent Application Publication
(10) Pub. No.: US 2004/0268416 A1
(43) Pub. Date: Dec. 30, 2004

(54) System and method for providing enhanced hot key control

(76) Inventors: James Harold Gray, Ellijay, GA (US); Thomas Jefferson Brothers, Gainesville, GA (US); William Randolpoh Matz, Atlanta, GA (US)

Correspondence Address: Scott P. Zimmerman PLLC, P.O. Box 3822, Cary, NC, 27519, US

(21) Appl. No.: 10/610,938

(22) Filed: Jun. 30, 2003

(51) Int. Cl. H04N 7/173; H04N 7/16

(52) U.S. Cl. 725/135; 725/110; 725/112; 725/113; 715/500.1; 715/501.1; 725/111

(57) ABSTRACT

According to various aspects of the present invention, methods and systems are provided for informing users of an interactive television service of available content during an advertisement or via an electronic program guide. A hot key signal is inserted into a content signal transmitted to the one or more users from an interactive television service provider via a network with which the one or more users and the interactive television service provider are connected. If the hot key signal is relevant to the user, an indication that the hot key signal has been received is displayed on the screen. If the user accepts the hot key, the user is redirected to the alternate content or is provided additional information regarding the available content.

### RELATED APPLICATIONS

This application is related to co-pending application number ______ filed on Jun. 30, 2003.

### FIELD OF THE INVENTION

The various embodiments of the invention disclosed herein relate generally to the field of interactive television. More particularly, these embodiments relate to providing enhanced hot key control.

### BACKGROUND OF THE INVENTION

Advances in telecommunications and computing technology have led to the use of interactive television (TV) services on a large scale. Where such services are available, users are not only able to access television content by passively receiving it, but are also beginning to interact with the service providers by communicating requests and/or commands to the service providers. These requests and/or commands may be communicated to the service provider via the same path over which the programming services are provided or even via other paths.

Interactive television may be provided over any number of paths, including coaxial cable or optical fiber, hybrid fiber/coaxial, or any other suitable path that accommodates sufficient bandwidth for desired video channels as well as other telecommunications services. Content providers may include, for example, providers of over-the-air programming such as commercial television stations, cable programming such as weather, travel and entertainment channels, game channels, and other interactive services of various types.

Generally, TV service provides a user or users with a variety of options such as: traditional broadcast and cable television programming; video services, such as pay-per-view (PPV), near video-on-demand (NVOD), video-on-demand (VOD), promo channels, electronic program guides, etc.; cable delivered PC-based services; and interactive services through the use of a combination of compression and digital video technologies. TV services may also provide menuing capabilities and upstream signaling from users to service providers.

The combination of broadcast and interactive applications over interactive TV (e.g., interactive content) creates a possible mode of communication in which a user, if informed of the availability of alternate interactive content relating to a subject matter of interest, may invoke the alternate content to investigate that subject matter more thoroughly and according to his or her own tastes. However, television viewers, who are accustomed to choosing at will between the available transmitted channels with instantaneous results, will expect to be informed of the alternate content in a convenient and timely manner and to pass from one medium to another seamlessly.

### SUMMARY OF THE INVENTION

A method and system are described that provide enhanced hot key control. According to one aspect of the present invention, a method comprises determining whether to inform one or more users of an interactive television service of available content during an advertisement. Responsive to determining to inform the one or more users of the available content during an advertisement a hot key signal is generated indicating availability and a location of the alternate content. The hot key signal is inserted into a content signal transmitted to the one or more users from an interactive television service provider via a network with which the one or more users and the interactive television service provider are connected.

According to another aspect of the present invention a method comprises determining whether to inform one or more users of an interactive television service of available content via an electronic program guide. Responsive to determining to inform the one or more users of the available content via an electronic program guide, a hot key signal is generated indicating availability and a location of the alternate content. The hot key signal is inserted into a content signal transmitted to the one or more users from an interactive television service provider via a network with which the one or more users and the interactive television service provider are connected.

According to yet another aspect of the present invention, a method comprises receiving a hot key signal related to an advertisement and indicating availability and a location of alternate content. A determination is made whether the hot key signal is relevant to a user of an interactive television (TV) provider currently viewing the advertisement. Responsive to determining the hot key signal is relevant to the user, an indication that the hot key signal has been received is displayed on the screen. Responsive to receiving an indication that the hot key is accepted, the user is redirected to the alternate content.

According to yet another aspect of the present invention, a method comprises receiving a hot key signal from an interactive television service provider's network, the hot key signal related to an electronic program guide, indicating availability and a location of alternate content and containing information providing details regarding the alternate content. A determination is made whether the hot key signal is relevant to a user of the interactive television service provider. Responsive to determining the hot key signal is relevant to the user, an indication that the hot key signal has been received is displayed on the screen.

Other features of the present invention will be apparent from the accompanying drawings and from the detailed description that follows.

### BRIEF DESCRIPTION OF THE DRAWINGS

The appended claims set forth the features of embodiments of the invention with particularity. The invention, together with its advantages, may be best understood from the following detailed description taken in conjunction with the accompanying drawings of which:

FIGS. 1A-1D illustrate a television displaying a picture containing a hot key for informing a user of available alternate content and redirecting the user to the alternate content responsive to selection of the embedded hot key according to one embodiment of the present invention;

FIGS. 2A through 2D illustrate a television displaying a picture containing a hot key presented while a user is viewing an electronic program guide according to one embodiment of the present invention;

FIG. 3 is a block diagram illustrating an exemplary network over which interactive television signals containing embedded hot key signals may be transmitted according to one embodiment of the present invention;

FIG. 4 is a block diagram of a head-end and data center system where hot key signals may be added to a transmitted signal according to one embodiment of the present invention;

FIG. 5 is a flowchart illustrating head-end and data center processing for adding hot key signals to a transmitted signal according to one embodiment of the present invention;

FIG. 6 is a diagram illustrating one possible format for a hot key data packet according to one embodiment of the present invention;

FIG. 7 is a block diagram of a user side system to redirect a user to alternate content responsive to selection of an embedded hot key according to one embodiment of the present invention;

FIG. 8 is a flowchart illustrating processing on a user side system for redirecting a user to alternate content responsive to selection of an embedded hot key according to one embodiment of the present invention; and

FIG. 9 is a flowchart illustrating processing on a user side system for presenting hot keys to a user viewing an electronic program guide and presenting additional program information responsive to selection of an embedded hot key according to one embodiment of the present invention.

### DETAILED DESCRIPTION OF THE INVENTION

In the following description, for the purposes of explanation, numerous specific details are set forth in order to provide a thorough understanding. It will be apparent, however, to one skilled in the art that embodiments of the present invention may be practiced without some of these specific details. In other instances, well-known structures and devices are shown in block diagram form.

Embodiments of the present invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, Compact Disk Read-Only Memories (CD-ROMs), and magneto-optical disks, Read-Only Memories (ROMs), Random Access Memories (RAMs), Erasable Programmable Read-Only Memories (EPROMs), Electronically Erasable Programmable Read-Only Memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

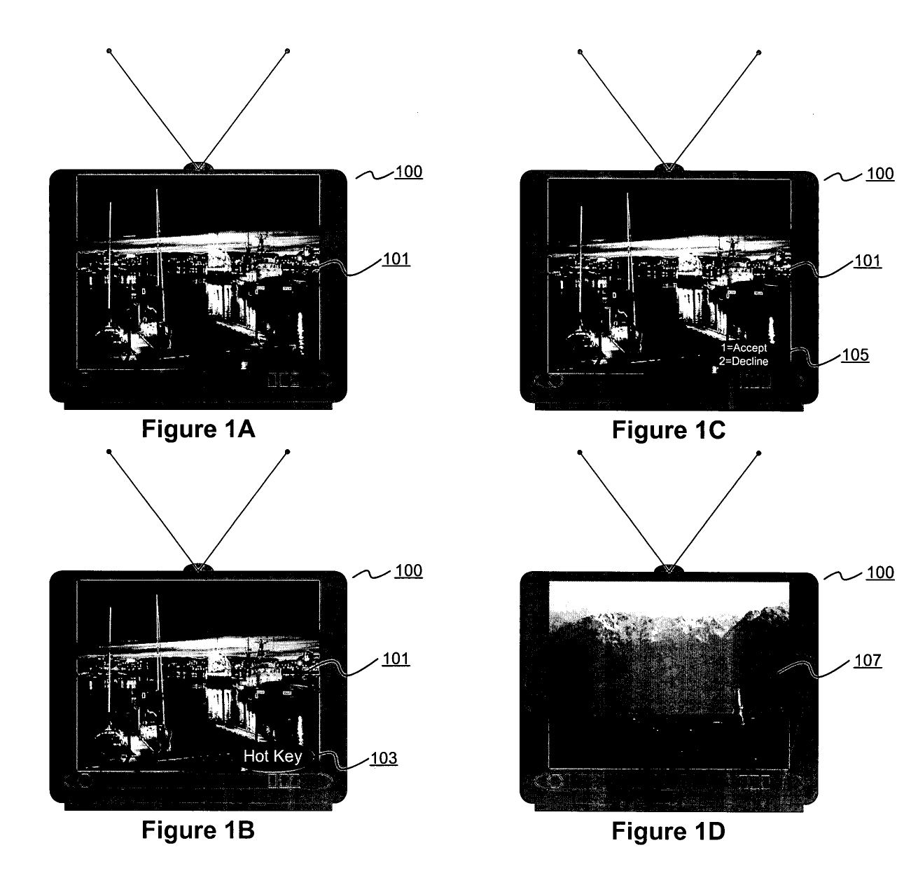

FIGS. 1A-1D illustrate a television displaying a picture containing a hot key for informing a user of available alternate content and redirecting the user to the alternate content responsive to selection of the embedded hot key according to one embodiment of the present invention. These figures represent respectively a process of viewing content, receiving a hot key, accepting a hot key, and redirecting to alternate content.

Specifically, FIG. 1A illustrates an example of viewing content. Here, a video program 101 is being displayed on television 100. Alternatively, a user may be viewing other types of interactive TV content such as pay-per-view video content, interactive games, etc.

FIG. 1B illustrates an example of receiving a hot key. In this example, the user is tuned to the same video program 101 on television 100 as in the previous example of FIG. 1A. However, in this example an icon 103 or other graphic has been displayed to indicate to the user that a hot key has been received. The hot key indicates that alternate content is available for the user's consumption. According to one embodiment of the present invention, the alternate content may be in the form of another video program with content related to the video program 101 being viewed by the user.

FIG. 1C illustrates an example of accepting a hot key. In this example, the user is tuned to the same video program 101 as in FIG. 1A and 1B Icon 105, displayed to indicate to the user that a hot key has been received, now indicates a manner in which the user may accept or decline the alternate content. In this example, icon 105 indicates that the user may press 1 to accept the alternate content or 2 to decline the alternate content.

Of course, other methods of accepting or declining the alternate content may be used. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Pressing the hot key button may be a manner in which the user accepts the alternate content and is redirected to that content without further interaction from the user. According to another embodiment, the user may decline the alternate content by taking no action at all. That is, after some time period during which no action is taken by the user to accept the alternate content, the hot key may simply time out and expire. Various other methods of accepting or declining the alternate content may also be used.

Regardless of the exact operation used to accept the alternate content, FIG. 1D illustrates redirecting a user to alternate content responsive to the hot key being accepted. According to one embodiment of the present invention, the alternate content may be another video program with content related to the video program 101 being viewed by the user. Therefore, television 100 in FIG. 1D illustrates an alternate video program 107 being displayed. According to one embodiment of the present invention, the alternate video program 107 may present content related to the original content the user was viewing. For example, if the user was viewing a television program related to travel, the alternate video program may also be related to travel.

According to another embodiment of the present invention, the alternate video program may be commercial in nature. For example, the television program may be related to sports. In such a case, the alternate video program may be a pay-per-view sporting event of the same type or an advertisement for an upcoming pay-per-view event. In another example, the alternate video program may be an “infomercial” selling merchandise related to some aspect of the original video content.

In one embodiment of the present invention, hot key signals may be associated with commercials. For example, a hot key signal may be inserted into a commercial for a particular automobile. The hot key will be displayed on the users screen during the commercial. Acceptance of the hot key by the user may redirect the user to a longer, more detailed commercial or even redirect the user to the manufacturers Internet web site for more information.

Therefore, content providers and/or service providers may be able to sell hot keys just as they currently sell time for commercial spots. For example, a provider of pay-per-view video content may wish to purchase from a content provider a hot key that redirects users to his content or an advertisement of upcoming events during a television program related to that content. Alternatively, content providers may charge users to receive a hot key service or even to block some or all hot key signals. Content providers and/or service providers may thus be able to realize an additional source of revenue.

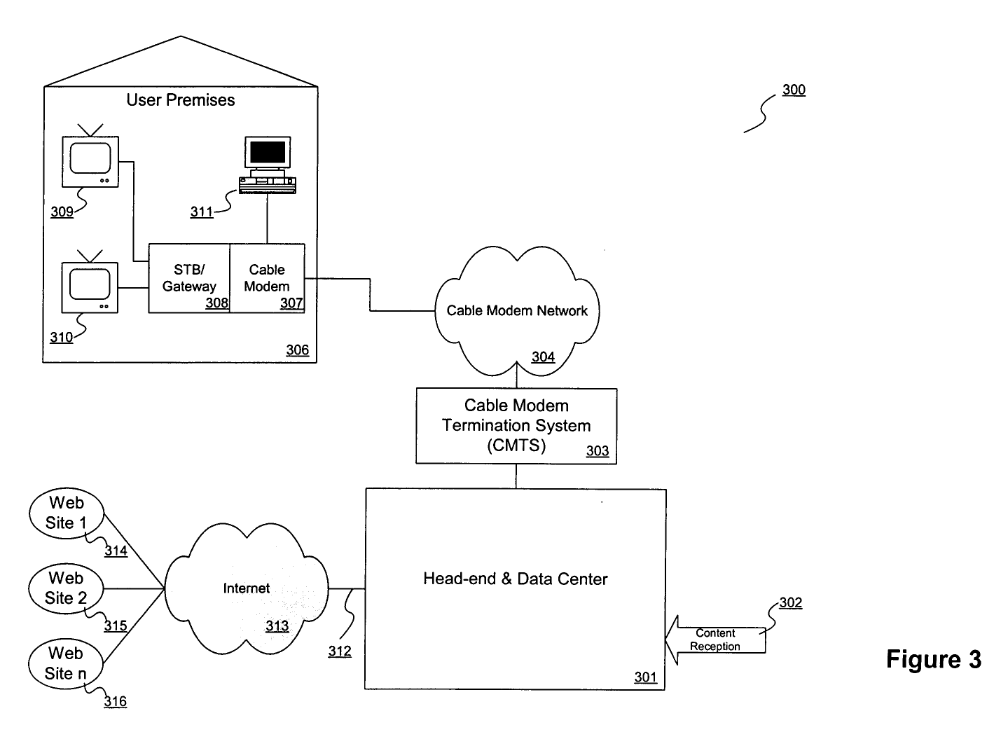

As will be described below with reference to FIG. 3, a system over which interactive television signals containing embedded hot key signals may be transmitted according to various embodiments of the present invention may be implemented over different types of networks. These different types of networks include, but are not limited to, cable, satellite, Fiber-to-the-Curb (FTTC), Fiber-to-the-House (FTTH), Very high speed Digital Subscriber Line (VDSL), and others.

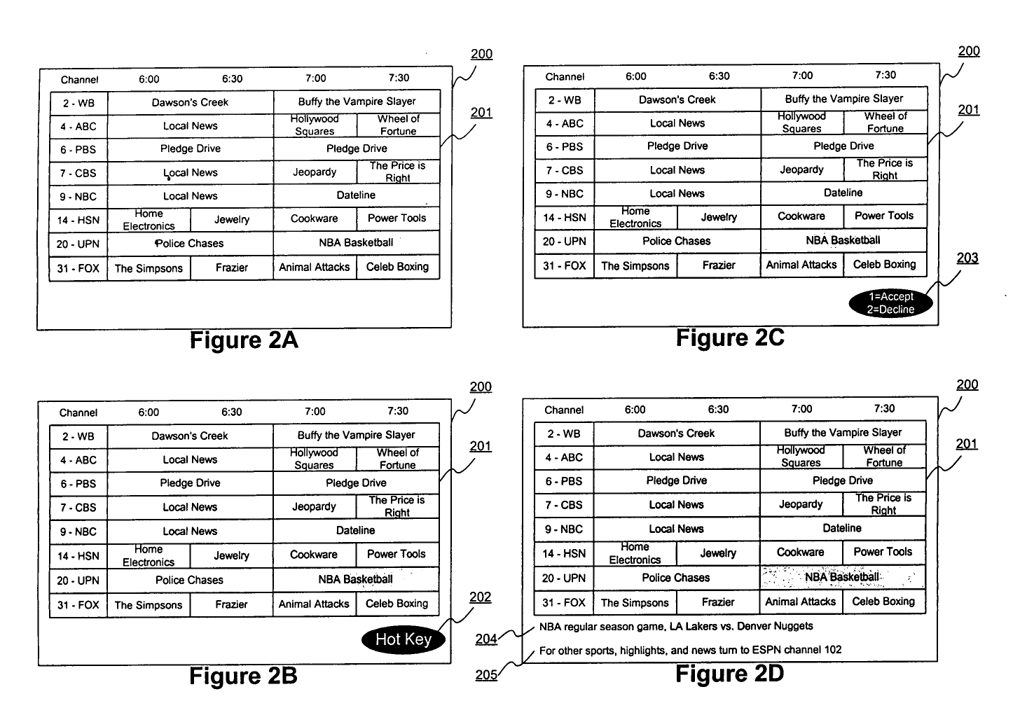

FIGS. 2A through 2D illustrate a television displaying a picture containing a hot key presented while a user is viewing an electronic program guide according to one embodiment of the present invention.

FIG. 2A illustrates an example of viewing an electronic program guide. Here, a generic electronic program guide 200 is being displayed. The electronic program guide 200 includes a grid 201 representing channels and time slots and displaying the programming content for each. Alternatively, other formats and types of electronic program guides may be used.

FIG. 2B illustrates an example of receiving a hot key. In this example, the user is tuned to the same electronic program guide 200 as the previous example. However, in this example the user has selected a specific program of interest using his remote control or a pointing device. Additionally, an icon 202 or other graphic has been displayed to indicate to the user that a hot key has been received for that program. The hot key indicates that information and/or alternate content related to the selected program is available for the user's consumption. According to one embodiment of the present invention, the alternate content may be in the form of another video program with content related to the video program 101 being viewed by the user.

FIG. 2C illustrates an example of accepting a hot key. In this example, the user is tuned to the same electronic program guide 200 as the previous examples. Icon 203, displayed to indicate to the user that a hot key has been received, now indicates a manner in which the user may accept or decline the information or alternate content. In this example, icon 203 indicates that the user may press 1 to accept the information or alternate content or 2 to decline the alternate content.

Of course, other methods of accepting or declining the information or alternate content may be used. For example, different single or even multiple buttons on a remote control may be pressed by the user to accept or decline the information or alternate content. According to one embodiment, a single “hot key button” may be present on the user's remote control that may be pressed by the user whenever a hot key icon is present on the television display. Pressing the hot key button may be a manner in which the user accepts the information or alternate content and is redirected to that information or content without further interaction from the user. According to another embodiment, the user may decline the information or alternate content by taking no action at all. That is, after some time period during which no action is taken by the user to accept the hot key, the hot key may simply time out and expire. Various other methods of accepting or declining the information or alternate content may also be used.

Regardless of the exact operation used to accept the information or alternate content, FIG. 2D illustrates presenting program information responsive to the hot key being accepted. According to one embodiment of the present invention, the program information may be a description 204 providing additional details of the program selected. Additionally, or alternatively, the information may be a message 205 informing the user of related alternate content on another channel.

Therefore, content providers and/or service providers may be able to sell hot keys just as they currently sell time for commercial spots. For example, a provider of pay-per-view video content may wish to purchase from a content provider a hot key that informs users to his content when the user is “surfing” an electronic programming guide. Alternatively, content providers may charge users to receive a hot key service or even to block some or all hot key signals. Content providers and/or service providers may thus be able to realize an additional source of revenue.

FIG. 3 is a block diagram illustrating an exemplary network over which interactive television signals containing embedded hot key signals may be transmitted according to one embodiment of the present invention. This example illustrates, at a high-level, an architecture of a service provider's system 300 that includes head-end and data center 301, Cable Modem Termination System (CMTS) 303, cable modem network 304, and user premises 306 that also contains cable modem 307, Set Top Box (STB)/Gateway 308, one or more televisions 309 and 310, and possibly other devices such as personal computer (PC) 311.

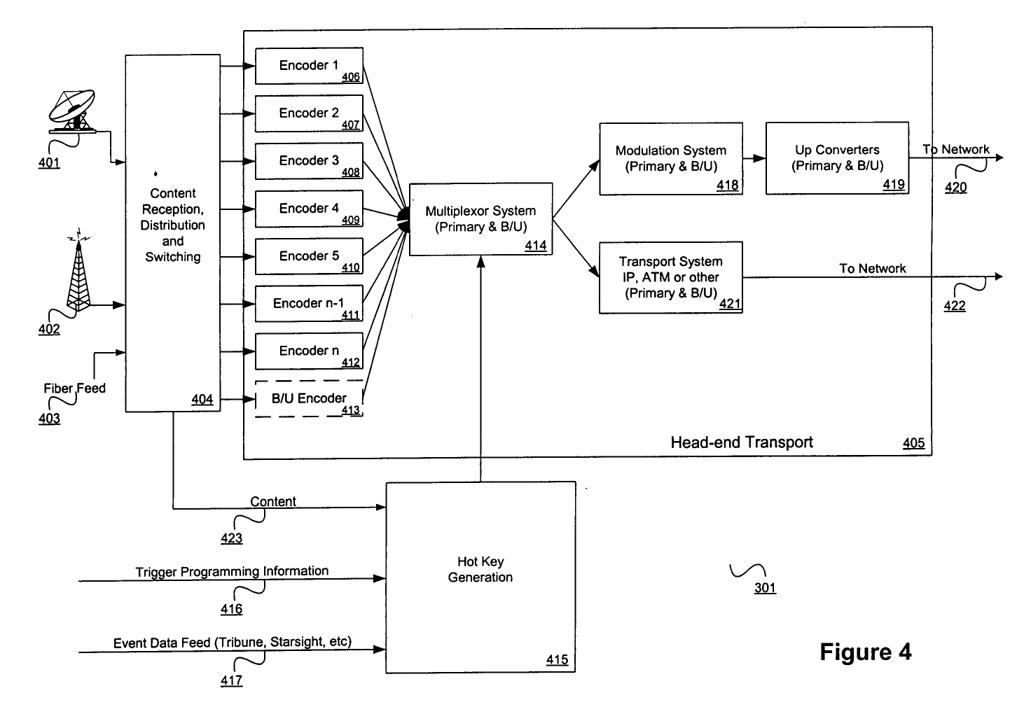

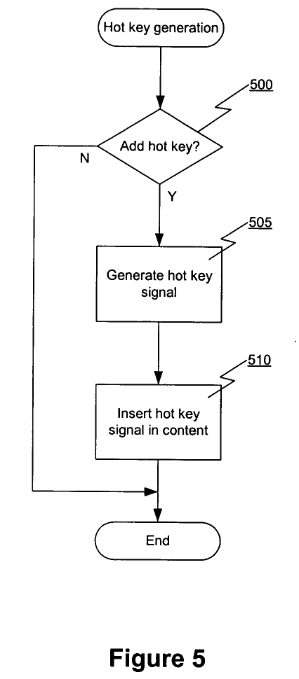

An interactive TV service provider typically operates and maintains a head-end and data center 301 equipped to receive signals 302 from one or more content providers. Content providers may be any original or secondary source of programming or information generally including, for example, interactive or non-interactive over-the-air programming such as commercial television stations, cable programming such as weather, travel and entertainment channels, game channels, and other interactive services of various types. Head-end and data center 301, after receiving content from one or more content providers, may then transmit the interactive content to users premises 306. Further details of the hardware comprising the head-end and data center 301 as well as the processing performed therein will be discussed below with reference to FIGS. 4 and 5.

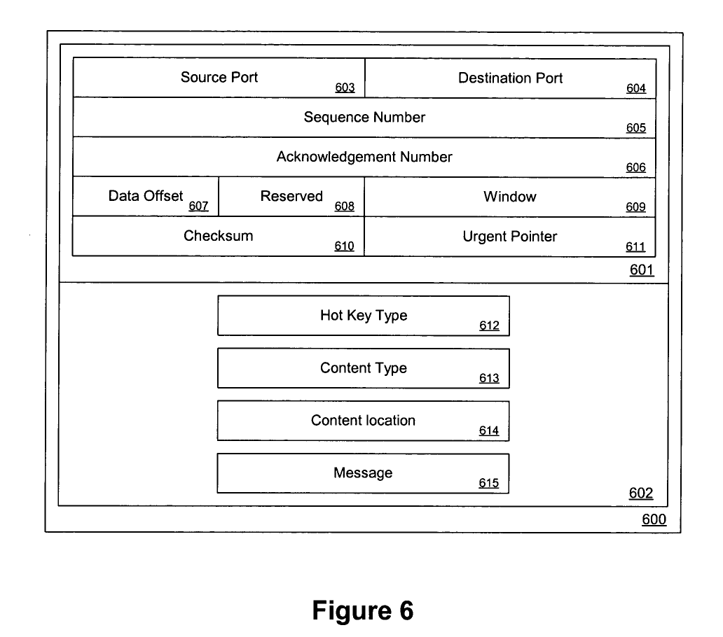

According to one embodiment of the present invention, hot key signals indicating the availability of alternate content may be provided to head-end and data center 301 along with and embedded in interactive TV signals 302 from the content providers. For example, the hot key signals may be generated at the content provider's location by an operations team when preparing and scheduling content for transmission to various service providers. As will be discussed below, interactive TV signals with these embedded hot key signals are transmitted from head-end and data center 301 and are received and used by STB/gateway 308 or PC 311 at user premises 306 to inform the user of the availability of alternate content and to guide the user to this content if he chooses to accept it. Details of the hot key signals will be discussed below with reference to FIG. 6.

According to another embodiment of the present invention, hot key signals indicating the availability of alternate content may be generated at head-end and data center 301. For example, the hot key signals may be generated at head-end and data center 301 by an operations team when preparing and scheduling content for transmission to users. As will be discussed below, these embedded hot key signals are transmitted from head-end and data center 301 and are received and used by STB/gateway 308 or PC 311 at user premises 306 to inform the user of the availability of alternate content and to guide the user to this content if he chooses to accept it.

In the example illustrated in FIG. 3, a signal carrying interactive TV content is transmitted from head-end and data center 301 through CMTS 303 and onto cable modem network 304. Typically, transmissions over cable modem network 304 may be made in a digital form. For example, the content may be transmitted as a Motion Pictures Experts Group Standard 2 (MPEG-2) data stream using a network protocol such as Internet Protocol (IP). Therefore, the content may be transmitted from head-end and data center 301 as IP data packets or in another similar format. One possible example of such a packet will be discussed below with reference to FIG. 6.

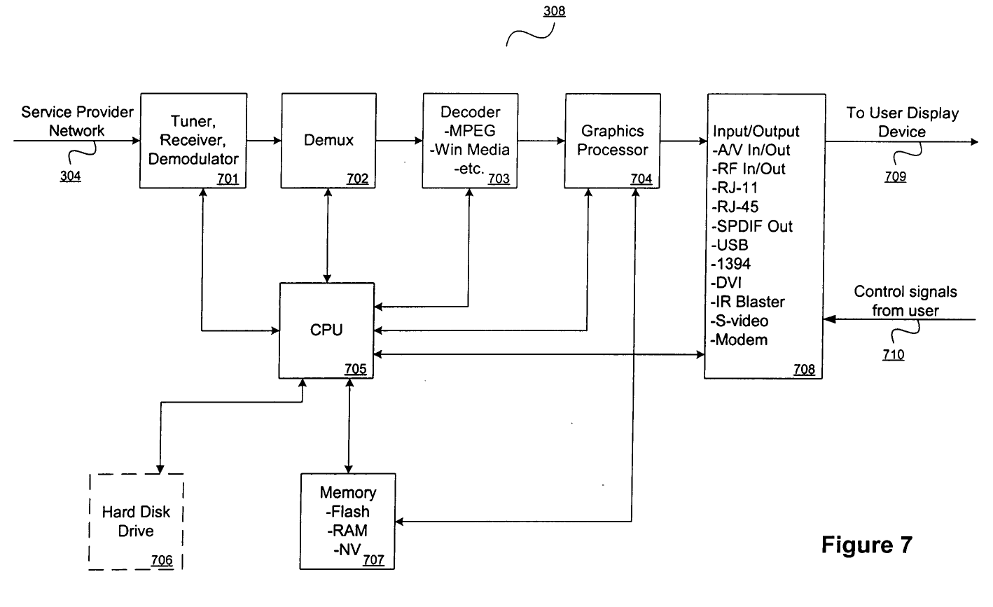

Regardless of the format of the transmission, a signal carrying the interactive TV content is received at user premises 306 via cable modem 307. Connected with cable modem 307 may be some form of terminal device. In the example illustrated by FIG. 3, two possible types of terminal devices, STB/Gateway 308 and PC 311 are shown. The terminal device, STB, Gateway, PC or other device, performs functions such as exchanging messages (including video-related data) over a network with head-end and data center 301, receiving messages from a user input device, such as a hand-held remote control unit or keyboard, translating video signals from a network-native format into a format that can be used by televisions 309 and 310 or other display devices, and providing a video signal to televisions 309 and 310 or other display devices. STB/Gateway 308 and PC 311 may also be capable of performing other functions, such as inserting alphanumeric or graphical information into the video stream in order to “overlay” that information on the video image, providing graphic or audio feedback to a user, or routing a traditional broadcast signal to a viewing device to which another STB is connected. Additional details of the hardware of STB/Gateway 308 and the processing performed therein will be discussed below with reference to FIGS. 7 through 9.

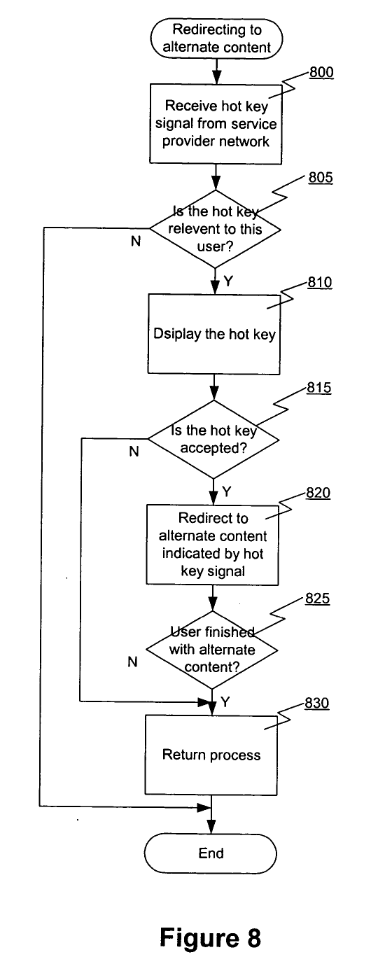

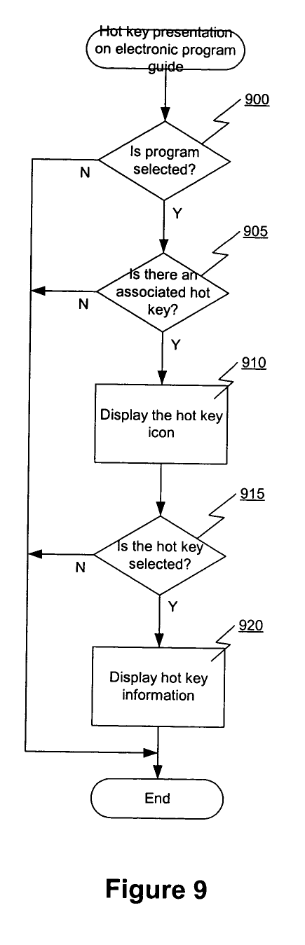

In use, STB/Gateway 308 or PC 311 may receive hot key signals embedded in the interactive TV signals by either the content providers or the service provider. STB/Gateway 308 or PC 311 may then notify the user of available alternate content as discussed above with reference to FIGS. 1 and 2. STB/Gateway 308 or PC 311 may then receive some form of user feedback indicating that the user accepts or declines the alternate content. If the user accepts the alternate content, STB/Gateway 308 or PC 311 may then redirect the user to this alternate content as will be discussed further below with reference to FIGS. 8 and 9.

According to one embodiment of the present invention, head-end and data center may also be connected with the Internet 313 or other network via a high-speed connection 312 such as a fiber optic connection to provide access to a number of web sites 314-316. Through this connection 312, head-end and data center 301 may supply alternate content to users from one or more of the number of web sites 314-316.

FIG. 4 is a block diagram illustrating a head-end and data center system where hot key signals may be added to a transmitted signal according to one embodiment of the present invention. This example illustrates head-end and data center system 301 comprising content reception, distribution, and switching portion 404, head-end transport portion 405, and hot key generation system 415.

Content reception, distribution, and switching portion 404 is connected with one or more of satellite receiver 401, over the air transmission receiver 402, fiber optical feed 403, and other types of links (not shown) to receive signals from one or more content providers. Content reception, distribution, and switching portion 404 comprises equipment that that is commonly used to receive transmitted signals, demodulate the transmitted signals to separate the content signals from a carrier signal if necessary, distribute and arrange the content from the content providers to fit a programming schedule of the service provider, and provide switching of these signals between the various components of the head-end and data center 301.

Head-end transport portion 405 comprises a plurality of encoders 406-412, optional back-up encoder 413, multiplexor system 414, modulation system 418, up converters 419, and transport system 421. Encoders 405-412 and optional back-up encoder 413 receive interactive TV content signals from content reception, distribution, and switching portion 404 and encode the content signals into any of a variety of well known formats such as Motion Pictures Experts Group Standard 2 (MPEG-2), Motion Pictures Experts Group Standard 4 (MPEG-4), DivX, or any other format. Encoders 405-412 and optional back-up encoder 413 each provide an individual encoded data stream representing the content signal of a single channel to multiplexor system 414.

Hot key generation system 415 is also connected with multiplexor system 414 of head-end transport 405. Hot key generation system 415 receives content 423 from content reception, distribution, and switching portion 404, trigger programming information 416, and event data feed 417. Trigger programming information 416 provides an indication of the time, date, etc. that given content will be played out. Event data feed 417 provides live content rather than content that is programmed and played out at a scheduled time. Using content 423, trigger programming information 416, and event data feed 417 hot key generation system 415 generates hot key signals associated with content to be transmitted from head-end and data center 301 and outputs the hot key signals to multiplexor system 414. Exemplary processes for generating hot key signals as may be performed by hot key generation system 415 will be discussed below with reference to FIG. 5.

Multiplexor system 414 may comprise a primary as well as an optional back-up multiplexor. Multiplexor system 414 combines the encoded content signals from encoders 405-412 and optional back-up encoder 413 and hot key signals from hot key generation system 415 to provide an output data stream. The output stream of multiplexor system 414 comprises the individual encoded data streams representing the content signals of the individual channels as well as any associated hot key signals.

The output stream of multiplexor system 414 may be applied to a modulation system 418. Modulation system 418 may comprise a primary as well as an optional back-up modulator. Modulation system 418 uses the output data stream of multiplexor system 414 to modulate a carrier frequency for transmission from the head-end system 301.

Modulation system 418 supplies the modulated carrier signal to up converters 419. Up converters 419 may comprise primary as well as optional back-up converters. Additionally, up converters 419 may comprise multiple stages of converters. The function of up converters 419 is to increase the modulated carrier frequency to a range that is suitable for transmission. Up converters 419 then transmit the modulated carrier signal from head-end and data center 301 via network 420 to users.

Optionally, or in addition to modulation system 418, the output of multiplexor system 414 may be applied to transport system 421 that may comprise a primary as well as an optional back-up transport system. The function of the transport system 421 is to prepare the output stream of multiplexor system 414 for transmission over network 422. That is, transport system 421 places the output stream of multiplexor system 414 into a format and protocol appropriate for network 422. For example, the output stream of multiplexor system may be placed into Internet Protocol (IP) packets or placed into an Asynchronous Transfer Mode (ATM) channel by transport system 421.

FIG. 5 is a flowchart illustrating head-end and data center processing for adding hot key signals to a transmitted signal according to one embodiment of the present invention. This process may be performed by a system such as the hot key generation system of the head-end and data center described above with reference to FIG. 4 or any other system with similar capabilities.

First, at decision block 500, the system determines whether a hot key signal should be added to the current content. This determination may be made by an operations team when scheduling or otherwise preparing content for transmission to users. For example, when preparing a programming schedule, an operations team may identify related content and designate a hot key to be sent during the transmission. This determination may be made by a local television operator such as a decision to provide a hot key on a local advertisement that gives the user the opportunity to find out more about a local product. Alternatively, this determination may be made by an original national content provider such as a national network to provide a hot key to all users or to users living in a certain state or region.

If a hot key signal is to be added to the current content, the hot key signal may be generated at processing block 505. According to one embodiment of the present invention, the hot key signal may comprise a special purpose Internet Protocol (IP) packet as described below with reference to FIG. 6. Alternatively, the hot key signal may be any other type of digital signal or packet suitable for transmission over the type of network being used and capable of carrying information similar to that shown in FIG. 6.

Finally, at processing block 505, the hot key signal is inserted into the content signal. That is, the hot key IP packet or other signal is multiplexed with the content data stream as described above with reference to FIG. 4.

FIG. 6 is a diagram illustrating one possible format for a hot key data packet according to one embodiment of the present invention. This example illustrates an IP data packet 600. The IP data packet includes a header 601 and a body 602.

Header 601 includes a number of fields 603-611 that are typically found in IP data packets. These fields include a source port 603, a destination port 604, a sequence number 605, an acknowledgement number 606, a data offset 607, a reserved field 608, a window field 609, checksum data 610, and an urgent pointer 611. It should be noted that such an IP data packet may be sent to multiple address using IP multicasting. Multicasting therefore allows efficient transmission of the hot key signals from the head-end and data center to users.

Body 602 may also include a number of fields 612-615. These fields may include a hot key type 612, a content type 613, a content location 614, and a message field 615. In various applications, the number of fields used, size of the fields, type of data presented, format of the data, content of the fields, etc. may vary. For example, in some cases not all of the fields presented here may be used. In other cases, additional data may be presented such as additional graphical or textual information. Additionally, the data may be presented in a wide variety of formats such as plain American Standard Code for Information Interchange (ASCII) text, other binary representations or even encrypted.

Regardless of format, hot key type field 612 may represent the type of hot key signal being used. For example, the hot key signal represented by IP data packet 600 may indicate that alternate content is available on another channel or on a web site. Alternatively, the hot key signal may indicate that alternate content is available to be cached on the user's terminal device. According to one embodiment of the present invention, hot key type field 612 may indicate that the hot key is associated with an electronic program guide. Additionally, this field, or another field, may contain data associating the hot key with a specific channel. For example, the hot key type field 612 may indicate that this is a hot key for an electronic program guide when channel 4 is selected.

Content type field 613 may represent the type, genre, or other details about the alternate content. For example, this field 613 may be used to indicate that the alternate content is a sporting event or movie. Of course, additional details may also be included. For example, the field 613 may indicate that the alternate content is an action movie and name the actors and director. This information may be used by the user's terminal device to judge the relevance of the hot key signal to the user as will be discussed below.

Content location field 614 may indicate where the alternate content is located. For example, this field 614 may indicate another channel, a web site URL or indicate that the content has been cached on the user's terminal device.

Message field 615 may include additional textual or graphical information regarding the hot key or the alternate content. As discussed above with reference to FIGS. 1 and 2, the message field 615 may contain a text message to be displayed to the user providing details of the alternate content. This message may be presented to the user automatically or at his option to help the user decide whether to accept or decline the hot key.

FIG. 7 is a block diagram illustrating a user side system to redirect a user to alternate content responsive to selection of an embedded hot key according to one embodiment of the present invention. As discussed above, the user side system may vary significantly. The user side system comprising a terminal device, STB, Gateway or similar device, performs functions such as exchanging messages (including video-related data) over a network with head-end and data center, receiving messages from a user input device, such as a hand-held remote control unit, translating video signals from a network-native format into a format that can be used by televisions or other display devices, providing a video signal to televisions or other display devices, and other functions.

The functionality of the user side system may reside in a stand-alone device, literally a box that can be placed on, or at least near, the television, that is similar in outward form to conventional devices for receiving cable programs. The user side system functionality could alternatively be performed by hardware resident elsewhere, such as within the television or display console, or by any suitably equipped terminal device. Since the hardware may be proprietary to the service provider and may generally be a physically independent device, the term set top box is used here, but any type of terminal device with similar functionality may be used.

In the example illustrated in FIG. 7, the user side system comprises an STB 308. STB 308 comprises tuner, receiver, demodulator 701, demultiplexor 702, decoder 703, graphics processor 704, central processing unit (CPU) 705, optional hard disk drive 706 or other mass storage device, memory 707, and various possible inputs and outputs 708.

Tuner, receiver, demodulator 701 receives signals from the service provider network 304 over any of a variety of media as discussed above. Specifically, tuner, receiver, demodulator 701 receives signals of a frequency band to which it is tuned and demodulates the signals to remove content signals from a carrier signal if any. Demodulated content signals are then supplied by tuner, receiver, demodulator 701 to demultiplexor 702.

Demultiplexor 702 receives the demodulated content signals from tuner, receiver, demodulator 701 and separates the content into multiple data streams representing various channels. The multiple data streams are then supplied as an input to decoder 703.

Decoder 703 receives the multiple data streams from demultiplexor 702 and decodes or decompresses the data streams using an appropriate algorithm. For example, if the head-end and data center compressed the video signals into an MPEG-2 data stream, decoder 703 will decode the MPEG-2 data stream from demultiplexor 702 to form a standard video signal. The video signal from decoder 703 is then supplied to graphics processor 704.

Graphics processor 704 receives the decoded video signals from decoder 703 and processes the video signals to reduce noise, provide amplifications, etc. Processed video signals from graphics processor 704 are supplied to input/output module 708. Input/output module 708 may provide a variety of possible output types. For example, outputs may include but are not limited to Audio/Video (A/V), Radio Frequency (RF), Sony/Phillips Digital Interface (SPDIF), Universal Serial Bus (USB), and others.

Input/output module 708 also receives also receives control signals from the user. These control signals are typically InfraRed (IR) or Radio Frequency (RF) signals from a remote control unit. Control signals from the user are then fed back from input/output module 708 to Central Processing Unit (CPU) 705.

CPU 705 executes instructions stored in memory 707. Memory 707 may comprise A Random Access Memory (RAM) such as flash memory, or other non-volatile memory. The instructions stored in memory 707, when executed by CPU 705 cause CPU 705 to perform various functions such as controlling the various elements of STB 308, receiving hot key signals, and switching to alternate content responsive to selection of an embedded hot key as will be described below with reference to FIGS. 8 and 9.

Generally, a hot key signal will be received at tuner, receiver, and demodulator 701 along with and embedded in content signals from the head-end and data center and transmitted over service provider network 304. CPU 705 monitors the demultiplexed data streams from demultiplexor 702 for the presence of relevant hot key signals.

STB 308 may also contain an optional hard disk drive 706 or other mass storage device. Hard disk drive 706 allows STB 308 to cache alternate content for later viewing by the user. If CPU 705 detects a hot key signals instructing content to be cached, the demultiplexed data stream from demultiplexor 702 may be saved on hard disk drive 706. The still compressed content is stored on hard disk drive 706 until the user chooses to view it. Once the user chooses to view the cached content, CPU 705 may retrieve the content from hard disk drive 706 and provide the compressed data stream to be decoded by decoder 703, processed by graphics processor 704, and output through input/output module 708.

According to one embodiment of the present invention, hot key signals from the content providers or service provider may be associated with advertisements. For example, a local television operator may provide a hot key on a local advertisement that gives the user the opportunity to find out more about a local product. Alternatively, an original national content provider such as a national network may provide a hot key to all users or to users living in a certain state or region.

FIG. 8 is a flowchart illustrating processing on a user side system for receiving and redirecting a user to alternate content responsive to selection of an embedded hot key according to one embodiment of the present invention. This process may be performed by a system such as described above with reference to FIG. 7 or any other system with similar capabilities.

First, at processing block 800, the system receives a hot key signal from the service provider's network. As discussed above, the hot key signal may be in the form of a specialized IP packet or another type of signal embedded in the content signal from the service provider.

At decision block 805 a determination is made as to whether the hot key signal is relevant to the particular user. Since numerous hot key signals may be transmitted at any particular time, the signals may be filtered before being presented to the user. Such filtering may be based on any number of possible algorithms and criteria. For example, only hot key signals related to a channel that is presently being viewed may be considered relevant. Another criteria for determining relevance of a hot key signal may be choices of content type or genres which have been selected by the user. Regardless of the algorithm or criteria used to judge relevance, if the hot key signal is determined at decision block 805 to not be relevant, no further processing is performed.

If the hot key signal is determined at decision block 805 to be relevant to the user, a hot key icon or other indication is displayed to the user at processing block 810. As mentioned above, this indication may be in the form of an icon placed on the screen, a text message, a tone or even a verbal alert. Regardless of the exact form, some indication is given to the user that a hot key has been received.

At decision block 815 a determination is made as to whether the user has accepted the hot key. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 815 that the user did not accept the hot key, no further processing is performed.

If, at decision block 815, the user accepts the hot key, the user is redirected to the alternate content at processing block 820.

At decision block 825 a determination is made as to whether the user has finished consuming the alternate content. This determination may be based on any of a variety of possible criteria. For example, the user may press a button or series of buttons on a remote control to indicate that he has finished viewing the presented material. Alternatively, the user may use a mouse or other pointing device of a remote control to select a graphic on the display to indicate that he has finished viewing the presented material.

Once a determination is made at decision block 825 that the user is finished with the alternate content, a return process is entered at processing block 830. This return process may include simply returning the user to the previous content. Alternatively, the return process may comprise presenting to the user other available content based on other hot key signals. Another alternative may include presenting a user with a number of choices of how to proceed.

FIG. 9 is a flowchart illustrating processing on a user side system for presenting hot keys to a user viewing an electronic program guide and presenting additional program information responsive to selection of an embedded hot key according to one embodiment of the present invention. This process may be performed by a system such as described above with reference to FIG. 7 or any other system with similar capabilities.

First, at decision block 900, a determination is made regarding whether a program has been selected from the electronic programming guide. A user may select a program from the electronic programming guide by using his remote control or another input device to highlight or otherwise indicate interest in the program. If, at decision block 900, a determination is made that a program has been selected, a determination is made at decision block 905 as to whether a hot key signal has been received for this program. This determination may be based on data associated with the hot key signal such as a data field in the body of an IP packet such as the one discussed above with reference to FIG. 6. For example, the body of such a hot key signal packet may include a field representing the channel to which the hot key is related.

If, at decision block 905, a determination is made that a hot key signal has been received for the selected program, the hot key icon or other indication will be displayed at processing block 910. As mentioned above, this indication may be in the form of an icon placed on the screen, a text message, a tone or even a verbal alert. Regardless of the exact form, some indication is given to the user that a hot key has been received.

Next, at decision block 915, a determination is made regarding whether the hot key has been accepted by the user. As discussed above, the user may use any of a variety of means to indicate acceptance of the hot key. For example, different single or even multiple buttons on a remote control may be pressed by the user to accept or decline the alternate content. According to one embodiment, a single “hot key button” may be present on the user's remote control that may be pressed by the user whenever a hot key icon is present on the television display. Regardless of the exact means of accepting or declining the hot key, if it is determined at decision block 915 the user did not accept the hot key, no further processing is performed.

If, at decision block 915, a determination is made that the user has accepted the hot key, the hot key information is displayed at processing block 920. As illustrated above in FIG. 2D, displaying the hot key information may comprise displaying in a portion of the display a text description of the content and/or an indication of other related content. This text may be data associated with the hot key signal such as a data field in the body of an IP packet such as the one discussed above with reference to FIG. 6. For example, the body of such a hot key signal packet may include a field representing the channel to which the hot key is related.

What is claimed is:

1. A method comprising:
determining whether to inform one or more users of an interactive television service of available content during an advertisement;
responsive to determining to inform the one or more users of the available content during an advertisement, generating a hot key signal indicating availability and a location of the alternate content; and
inserting the hot key signal into a content signal transmitted to the one or more users from an interactive television service provider via a network with which the one or more users and the interactive television service provider are connected.

2. The method of claim 1, wherein determining whether to inform one or more users of an interactive television service of available content during an advertisement is based on information supplied by a content provider.

3. The method of claim 2, wherein the content provider has paid the interactive television service provider to generate and transmit the hot key.

4. The method of claim 1, wherein determining whether to inform one or more users of an interactive television service of available content during an advertisement is based on information generated by the interactive television service provider.

5. The method of claim 1, wherein the one or more users of the interactive television service have paid the interactive television service provider to receive the hot key signal.

6. The method of claim 1, wherein the one or more users of the interactive television service have not paid the interactive television service provider to be excluded from receiving the hot key signal.

7. The method of claim 1, wherein the hot key signal comprises an Internet Protocol (IP) data packet, the IP data packet having a header portion and a body portion, the body portion having a data field indicating a location of the alternate content.

8. The method of claim 1, wherein the available content is related to content currently being viewed by the one or more users.

9. A method comprising:
determining whether to inform one or more users of an interactive television service of available content via an electronic program guide;
responsive to determining to inform the one or more users of the available content via an electronic program guide, generating a hot key signal indicating availability and a location of the alternate content; and
inserting the hot key signal into a content signal transmitted to the one or more users from an interactive television service provider via a network with which the one or more users and the interactive television service provider are connected.

10. The method of claim 9, wherein determining whether to inform one or more users of an interactive television service of available content via an electronic program guide is based on information supplied by a content provider.

11. The method of claim 9, wherein determining whether to inform one or more users of an interactive television service of available content via an electronic program guide is based on information generated by the interactive television service provider.

12. The method of claim 9, wherein the hot key signal comprises an Internet Protocol (IP) data packet, the IP data packet having a header portion and a body portion, the body portion having a data field indicating a location of the alternate content.

13. The method of claim 9, wherein the available content is related to content currently being viewed by the one or more users.

14. A method comprising:
receiving a hot key signal related to an advertisement and indicating availability and a location of alternate content;
determining whether the hot key signal is relevant to a user of an interactive television (TV) provider currently viewing the advertisement;
responsive to determining the hot key signal is relevant to the user, displaying on a screen an indication that the hot key signal has been received; and
responsive to receiving an indication that the hot key is accepted, redirecting the user to the alternate content.

15. The method of claim 14, wherein the hot key signal comprises an Internet Protocol (IP) data packet, the IP data packet having a header portion and a body portion, the body portion having a data field indicating a location for the alternate content.

16. The method of claim 14, wherein determining whether the hot key signal is relevant to the user comprises determining whether a destination address for the hot key signal is an address of the user.

17. The method of claim 16, wherein determining whether the hot key signal is relevant to the user further comprises determining whether the alternate content is related to content currently being viewed by the user.

18. A method comprising:
receiving a hot key signal from an interactive television service provider's network, the hot key signal related to an electronic program guide, indicating availability and a location of alternate content and containing information providing details regarding the alternate content;
determining whether the hot key signal is relevant to a user of the interactive television service provider; and
responsive to determining the hot key signal is relevant to the user, displaying on a screen an indication that the hot key signal has been received.

19. The method of claim 18, further comprising displaying to the user the information providing details regarding the alternate content.

20. The method of claim 18, further comprising responsive to the user requesting additional information, displaying to the user the information providing details regarding the alternate content.

21. The method of claim 18, further comprising responsive to receiving an indication that the hot key is accepted, displaying the alternate content to the user.

22. The method of claim 18, wherein the hot key signal comprises an Internet Protocol (IP) data packet, the IP data packet having a header portion and a body portion, the body portion having a data field indicating the location of the alternate content.

23. A system comprising:
a content reception, distribution, and switching portion connected with one or more content providers to receive and redistribute interactive television (TV) content;
a head-end transport portion connected with the content reception, distribution, and switching portion to and encode, multiplex and transmit content signals from the content reception, distribution, and switching portion over a network;
a hot key generation portion to determine whether to inform one or more users of an interactive television service of available content during an advertisement, responsive to determining to inform the one or more users of the available content during an advertisement, and generate a hot key signal indicating availability and a location of the alternate content.

24. The system of claim 23, wherein the head-end transport portion receives the hot key signal from the hot key generation portion, and multiplexes the hot key signal with the content signal.

25. The system of claim 23, wherein the hot key generation portion determines whether to inform one or more users of an interactive television service of available content during an advertisement based on information supplied by a content provider.

26. The system of claim 23, wherein the hot key generation portion determines whether to inform one or more users of an interactive television service of available content during an advertisement based on information generated by the interactive television service provider.

27. The system of claim 23, wherein the hot key signal comprises an Internet Protocol (IP) data packet, the IP data packet having a header portion and a body portion, the body portion having a data field indicating a location of the alternate content.

28. The system of claim 23, wherein the available content is related to content currently being viewed by the one or more users.

29. A system comprising:
a content reception, distribution, and switching portion connected with one or more content providers to receive and redistribute interactive television (TV) content;
a head-end transport portion connected with the content reception, distribution, and switching portion to and encode, multiplex and transmit content signals from the content reception, distribution, and switching portion over a network;
a hot key generation portion determine whether to inform one or more users of an interactive television service of available content via an electronic program guide, responsive to determining to inform the one or more users of the available content via an electronic program guide, and generate a hot key signal indicating availability and a location of the alternate content.

30. The system of claim 29, wherein the head-end transport portion receives the hot key signal from the hot key generation portion, and multiplexes the hot key signal with the content signal.

31. The system of claim 29, wherein the hot key generation portion determines whether to inform one or more users of an interactive television service of available content via an electronic program guide based on information supplied by a content provider.

32. The system of claim 29, wherein the hot key generation portion determines whether to inform one or more users of an interactive television service of available content via an electronic program guide based on information generated by the interactive television service provider.

33. The system of claim 29, wherein the hot key signal comprises an Internet Protocol (IP) data packet, the IP data packet having a header portion and a body portion, the body portion having a data field indicating a location of the alternate content.

34. The system of claim 29, wherein the available content is related to content currently being viewed by the one or more users.

35. A system comprising:
a tuner, receiver, and demodulator portion and a demultiplexor portion to receive a hot key signal related to an advertisement and indicating availability and a location of alternate content;
a processor to determine whether the hot key signal is relevant to a user of an interactive television (TV) provider currently viewing the advertisement, responsive to determining the hot key signal is relevant to the user, display on a screen an indication that the hot key signal has been received, and responsive to receiving an indication that the hot key is accepted, redirect the user to the alternate content.

36. The system of claim 35, wherein the hot key signal comprises an Internet Protocol (IP) data packet, the IP data packet having a header portion and a body portion, the body portion having a data field indicating a location for the alternate content.

37. The system of claim 35, wherein the processor determines whether the hot key signal is relevant to the user based on whether a destination address for the hot key signal is an address of the user.

38. The system of claim 37, wherein the processor determines whether the hot key signal is relevant to the user based on whether the alternate content is related to content currently being viewed by the user.

39. A system comprising:
a tuner, receiver, and demodulator portion and a demultiplexor portion to receive a hot key signal from an interactive television service provider's network, the hot key signal related to an electronic program guide, indicating availability and a location of alternate content and containing information providing details regarding the alternate content; and
a processor to determine whether the hot key signal is relevant to a user of the interactive television service provider, and responsive to determining the hot key signal is relevant to the user, display on a screen an indication that the hot key signal has been received.

40. The system of claim 39, wherein the processor displays to the user the information providing details regarding the alternate content.

41. The system of claim 39, wherein the processor, responsive to the user requesting additional information, displays to the user the information providing details regarding the alternate content.

42. The system of claim 39, wherein the processor, responsive to receiving an indication that the hot key is accepted, displays the alternate content to the user.

43. The system of claim 39, wherein the hot key signal comprises an Internet Protocol (IP) data packet, the IP data packet having a header portion and a body portion, the body portion having a data field indicating the location of the alternate content.

44. A machine readable medium having stored thereon a series of instructions, the instruction, when executed by a processor, cause the processor to:
determine whether to inform one or more users of an interactive television service of available content during an advertisement;
responsive to determining to inform the one or more users of the available content during an advertisement, generate a hot key signal indicating availability and a location of the alternate content; and
insert the hot key signal into a content signal transmitted to the one or more users from an interactive television service provider via a network with which the one or more users and the interactive television service provider are connected.

45. The machine readable medium of claim 44, wherein determining whether to inform one or more users of an interactive television service of available content during an advertisement is based on information supplied by a content provider.

46. The machine readable medium of claim 44, wherein determining whether to inform one or more users of an interactive television service of available content during an advertisement is based on information generated by the interactive television service provider.

47. The machine readable medium of claim 44, wherein the hot key signal comprises an Internet Protocol (IP) data packet, the IP data packet having a header portion and a body portion, the body portion having a data field indicating a location of the alternate content.

48. The machine-readable medium of claim 44, wherein the available content is related to content currently being viewed by the one or more users.

49. A machine readable medium having stored thereon a series of instructions, the instruction, when executed by a processor, cause the processor to:
determine whether to inform one or more users of an interactive television service of available content via an electronic program guide;
responsive to determining to inform the one or more users of the available content via an electronic program guide, generate a hot key signal indicating availability and a location of the alternate content; and
insert the hot key signal into a content signal transmitted to the one or more users from an interactive television service provider via a network with which the one or more users and the interactive television service provider are connected.

50. The machine readable medium of claim 49, wherein determining whether to inform one or more users of an interactive television service of available content via an electronic program guide is based on information supplied by a content provider.

51. The machine readable medium of claim 49, wherein determining whether to inform one or more users of an interactive television service of available content via an electronic program guide is based on information generated by the interactive television service provider.

52. The machine readable medium of claim 49, wherein the hot key signal comprises an Internet Protocol (IP) data packet, the IP data packet having a header portion and a body portion, the body portion having a data field indicating a location of the alternate content.

53. The machine-readable medium of claim 49, wherein the available content is related to content currently being viewed by the one or more users.

54. A machine readable medium having stored thereon a series of instructions, the instruction, when executed by a processor, cause the processor to:
receive a hot key signal related to an advertisement and indicating availability and a location of alternate content;
determine whether the hot key signal is relevant to a user of an interactive television (TV) provider currently viewing the advertisement;
responsive to determining the hot key signal is relevant to the user, display on a screen an indication that the hot key signal has been received; and
responsive to receiving an indication that the hot key is accepted, redirect the user to the alternate content.

55. The machine readable medium of claim 54, wherein the hot key signal comprises an Internet Protocol (IP) data packet, the IP data packet having a header portion and a body portion, the body portion having a data field indicating a location for the alternate content.

56. The machine-readable medium of claim 54, wherein determining whether the hot key signal is relevant to the user comprises determining whether a destination address for the hot key signal is an address of the user.

57. The machine readable medium of claim 54, wherein determining whether the hot key signal is relevant to the user further comprises determining whether the alternate content is related to content currently being viewed by the user.

58. A machine readable medium having stored thereon a series of instructions, the instruction, when executed by a processor, cause the processor to:
receive a hot key signal from an interactive television service provider's network, the hot key signal related to an electronic program guide, indicating availability and a location of alternate content and containing information providing details regarding the alternate content;
determine whether the hot key signal is relevant to a user of the interactive television service provider; and
responsive to determining the hot key signal is relevant to the user, display on a screen an indication that the hot key signal has been received.

59. The machine readable medium of claim 58, further comprising displaying to the user the information providing details regarding the alternate content.

60. The machine readable medium of claim 58, further comprising responsive to the user requesting additional information, displaying to the user the information providing details regarding the alternate content.

61. The machine-readable medium of claim 58, further comprising responsive to receiving an indication that the hot key is accepted, displaying the alternate content to the user.

62. The machine readable medium of claim 58, wherein the hot key signal comprises an Internet Protocol (IP) data packet, the IP data packet having a header portion and a body portion, the body portion having a data field indicating the location of the alternate content.
